(19) United States
(12) Patent Application Publication
(10) Pub. No.: US 2012/0113008 A1
(43) Pub. Date: May 10, 2012

(54) ON-SCREEN KEYBOARD WITH HAPTIC EFFECTS

(76) Inventors: Ville Makinen, (US); Moaffak Ahmed, (US); Marianne Kari, (US); Jukka Linjama, (US)

(21) Appl. No.: 13/288,749

(22) Filed: Nov. 3, 2011

Related U.S. Application Data
(60) Provisional application No. 61/411,398, filed on Nov. 8, 2010.

(51) Int. Cl. G08B 6/00; G06F 3/02

(52) U.S. Cl. 345/168

(57) ABSTRACT

A computer-implemented method is described for displaying an on-screen keyboard on a touch-sensitive display of an electronic device is described. The method may detect contact of a finger in a contact area of the display and monitor movement of the contact area on display in response to movement of the finger across the display. The method may determine that the contact area is proximate a region of the display that includes a key of the on-screen keyboard, and provide a haptic effect to indicate that the finger is proximate the at least one key. The haptic effect may be provided via the display and be provided proximate to the detected contact area. In an example embodiment, an anchor on one or more keys of the on-screen keyboard is provides a further haptic effect to the finger when the finger is proximate to the anchor.

### CROSS-REFERENCE TO RELATED APPLICATIONS

This application claims priority benefit under 35 U.S.C. 119(e) of U.S. Provisional Application No. 61/411,398, entitled, “ON-SCREEN KEYBOARD WITH HAPTIC EFFECTS” filed Nov. 8, 2010, which is incorporated herein by reference in its entirety.

### FIELD

The present disclosure relates generally to an on-screen keyboard with haptic effects. In an example embodiment, a virtual or on-screen keyboard that is displayed on a touch screen of an electronic device is provided.

### BACKGROUND

With the advent of the smart phone and other portable computing devices, there has been a proliferation of devices using touch screens to obtain user input. The touch screens display a virtual or on-screen keyboard and user interaction with the virtual keyboard is monitored. On-screen keyboards lack the feeling of physical keys and the touch confirmation upon selection or activation of a key by a user. In order to provide user feedback upon activation of a key, auditory and visual cues may be used. Some devices apply a vibratory motor that physically shakes or moves at least part of device to give confirmation when a user presses a key, but it is neither quiet nor suitable for devices larger in size than a mobile phone.

### BRIEF DESCRIPTION OF DRAWINGS

The present disclosure is illustrated by way of example, and not limitation, in the figures of the accompanying drawings, in which like references indicate similar elements and in which:

FIGS. 1A and 1B show schematic representations of virtual keyboards, in accordance with example embodiments, on a touch screen of an electronic device;

FIG. 2 shows a schematic representation of a display displaying a Graphical User Interface (GUI), in accordance with an example embodiment, with a keyboard area and a content area;

FIG. 3 shows a schematic representation of a display displaying a GUI, in accordance with an example embodiment, including a keyboard area, a content area, and a key proximity zone;

FIG. 4 shows a schematic representation of a display similar to the display of FIG. 3 but displaying a GUI, in accordance with an example embodiment, with a full ghost keyboard in a key proximity zone;

FIG. 5 shows a schematic representation of a display similar to the display of FIG. 3 but displaying a GUI, in accordance with an example embodiment, with a partial ghost keyboard in a key proximity zone;

FIG. 6 shows a schematic representation of a display similar to the display of FIG. 3 but displaying a GUI, in accordance with an example embodiment, with a partial ghost keyboard arranged linearly in a key proximity zone;

FIG. 7 shows a schematic representation of a display similar to the display of FIG. 3 but displaying a GUI, in accordance with an example embodiment, including a document content window;

FIGS. 8A and 8B show a schematic representation of a GUI including a virtual keyboard, in accordance with example embodiments, on a touch screen of an electronic device, with the virtual keyboard including special character selector;

FIG. 9 shows a schematic representation of a display displaying a GUI, in accordance with an example embodiment, with a slider bar corresponding to a selected key on a virtual keyboard;

FIG. 10 shows a schematic representation of a display displaying a GUI, in accordance with an example embodiment, including markers marking contact points or key selections of a user typing on a virtual keyboard;

FIG. 11 shows a schematic representation of an electronic device that may perform one or more of the methodologies described herein;

FIG. 12 shows an example state transition diagram of a method, in accordance with an example embodiment, for generating haptic effects;

FIG. 13 shows a method, in accordance with an example embodiment, for providing a haptic effect to a user of an on-screen keyboard;

FIG. 14 shows a method, in accordance with an example embodiment, for provide haptic feedback to a user of an on-screen keyboard to indicate an edge of a key or a central portion of the key;

FIG. 15 shows a method, in accordance with an example embodiment, for identifying anchor keys of an on-screen keyboard;

FIG. 16 shows a method of generating a modified visual representation, in accordance with an example embodiment, of at least one key of the on-screen keyboard;

FIG. 17 shows a method, in accordance with an example embodiment, for providing haptic feedback when a finger covers at least a portion of two or more keys of an on-screen keyboard;

FIG. 18 shows a method, in accordance with an example embodiment, for displaying a modified representation of at least one key proximate a contact area of an on-screen keyboard; and

FIG. 19 shows a block diagram of a computer processing system within which a set of instructions, for causing the computer to perform any one or more of the methodologies discussed herein, may be executed.

### DESCRIPTION OF EXAMPLE EMBODIMENTS

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

In an example embodiment, a virtual keyboard is presented on a touch-sensitive screen of an electronic device (e.g., an on-screen keyboard of a smart phone, tablet computer, or the like). The virtual keyboard is shaped and dimensioned to make it suitable to be used by a user interacting with a touch-sensitive surface with his or her fingers. In example embodiments, a haptic feedback is used to provide haptic feedback thereby to enhance a user experience and the ease of use of the keyboard.

In an example embodiment, the functionality provided to a user may include providing haptic feedback on finding a key on the virtual keyboard in order to reduce (or preferably minimize) accidental typing when using the on-screen or virtual keyboard, and provide haptic confirmation on selecting the key (e.g., during typing). Further, suitable visual cues may be provided to the user. Thus, in an example embodiment, a first phase in which a key is found or located by the user may be independent from a second phase when the user selects the key. In an example embodiment, a combination of visual, graphical, haptic and/or auditory elements may work together seamlessly in order to provide the user with an easy-to-learn, ergonomic, and comfortable typing solution on a touch screen of an electronic device.

Example embodiments may be used in conjunction with a touch screen device with an on-screen keyboard that is enabled with Senseg E-Sense haptic feedback technology available from Senseg Ltd. It is, however, to be appreciated that the example embodiments described herein, and variations thereof, are not limited to Senseg E-Sense technology and may be deployed in any virtual or on-screen keyboards or GUIs. For the purposes of this application, the words “haptic feedback” and “haptic effect” are used as synonyms and they are intended to include any kind of dynamic, time-variant effect that the user can feel when using a touch screen of any device. These effects can be created with any technology including, for example, active and passive actuators, form shaping technologies (that dynamically change the shape/feel of the surface) such as microfluids and electroactive polymers, electrocutaneous- and electrostatic-based technologies, or other feedback arrangements. In some example embodiments, temperature alternating technologies can be used to provide haptic feedback.

In an example embodiment, only one tixel (or a tactile pixel) is incorporated in the touch screen display. Accordingly, only one haptic feedback effect can be provided in a certain moment of time. However, in other example in embodiments, multiple tixels are provided allowing feedback in multiple positions or regions on a touch sensitive display screen. A touch input may be detected by capacitive input technology, but other input methods can be used as well (e.g., optical, resistive or the like). It should be noted that, the on-screen keyboard can be configured for any language and the visual layout presented in this application may be modified without departing from the scope of this application.

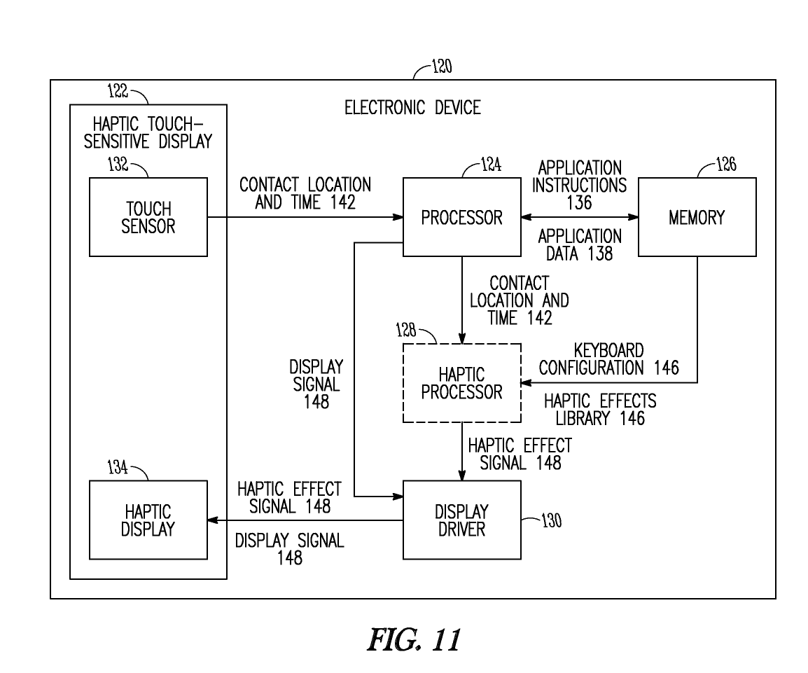

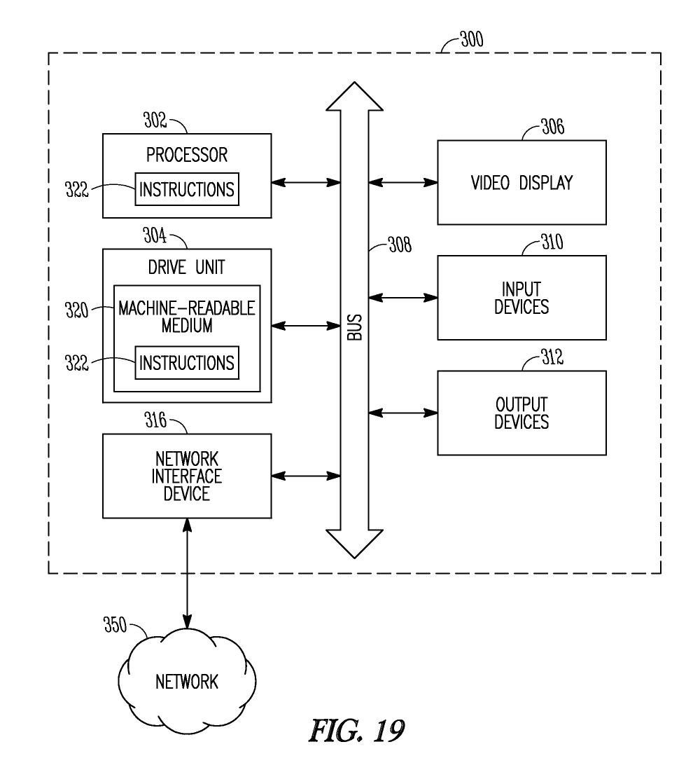

In example embodiments, multiple tixels offer different sensations to different areas of the surface of the on-screen keyboard. In these example embodiments, a touch screen is equipped with several haptic areas or regions (tixels) that vary in size from small to large. The size and number of tixels provided on an on-screen display may vary from device to device. Further, each tixel area or region may be controlled separately by control electronics (see, for example, FIGS. 11 and 19) and so, in multi-touch embodiments, different haptic feedback effects can be provided to each interacting finger. Example embodiments include electronic devices that have big or large touch screens, and several users may be able to type on the large screen at the same time. In these example embodiments, separate tixels may offer individual haptic feedback to each user and, accordingly, haptic feedback is only provided to a particular user typing in a particular area of the large screen.

In an example embodiment, two phases of user interaction with the on-screen keyboard to select a key may occur. In a first phase, when the user seeks or is looking for a key on the on-screen keyboard, circuitry may perform a seek operation (or operations). Once the user has identified a key (e.g., the user has slid a finger over the on-screen keyboard and it has come to rest on a key), a select operation (or operations) may be performed by the circuitry. During the select operation, the key is entered (e.g., into a display area, document, or the like as text) on a display. Example seek and select operations are described below.

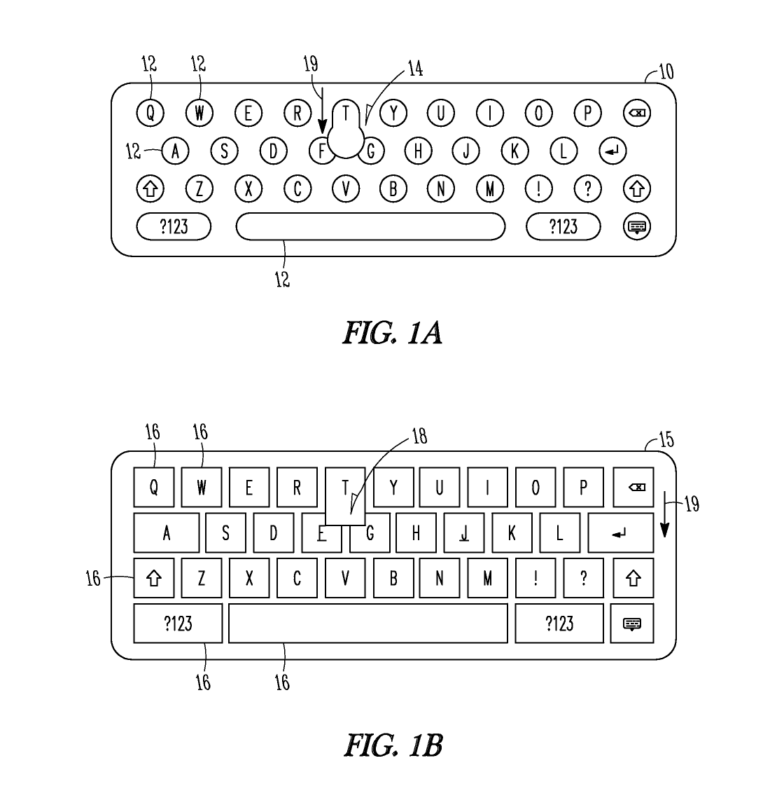

During an example seek operation, the user can move his or her finger(s) on the on-screen keyboard and feel (e.g., using haptic effects) the location of the soft keys. Seeking includes any sliding motion of the finger(s) on the keyboard area that is not in the downward direction (e.g., transverse to rows of the keyboard). The scale of sliding movement can be anything from short to long distances. In an example embodiment, the location of a key is indicated by a haptic effect and it can be used to distinguish the edges of (or spaces between) keys and/or locate the center of keys. In some example embodiments, both feedback types (e.g., with different haptic sensations) can be provided to the user. Every time a user has activated a key, an active (“receptive”) field of the key may expand the key in a downward direction. Thus, the user may provide an exploded view of a key to facilitate selection (e.g., see FIGS. 1-7).

Different haptic effects may be provided depending on the position of the finger or fingers on the on-screen keyboard. For example, for the key edges, haptic feedback is preferably offered as a short “click” effect as the border or edge of the key is crossed by the user's finger. This “haptic border” may be the same as the visual border or it can be a virtual one (but close to the visual representation). In an example embodiment, only the edges of the sides (vertical edges) can be felt by the user. In some example embodiments, haptic feedback is provided along all four edges (vertical and horizontal edges). The center of the key may be felt as a small area of haptic texture, which can be, for example, rough. Other kinds of suitable effects can be used as well.

In an example embodiment, the circuitry may be configured (e.g., programmed) to handle the accidental activation of multiple keys (error handling in ambiguous situations). For example, the disambiguation may be performed when multiple keys are activated simultaneously and haptic feedback to indicate contact with multiple keys may be provided. The haptic feedback may at least reduce the strain of typing on a touch-sensitive screen as the user does not constantly have to verify what was typed by looking at the screen. Keyboard implementations on touch-sensitive screens vary and at least some example embodiments handle the simultaneous multiple key activations by simply selecting one of the keys covered by the finger. Haptic or tactile feedback is provided in example embodiments to allow a user to slightly adjust or move her or his finger positioning on the on-screen keyboard so as to select only one key. This haptic feedback can be used in addition to key positioning feedback or it may be optional. When the two types of haptic feedback occur simultaneously, there is a clear distinction between the haptic effect provided when the user touches several keys and the haptic effect when a single key is located. For example, when several keys are touched, a haptic effect may be strong and long in duration to make the user aware of the error, whereas as the correct location of the finger on the key may be identified with a short and subtle haptic effect. It will, however, be appreciated that different example embodiments may include different haptic effects.

Once the user finds a key during the seek operation, the select operation may be performed. In an example embodiment, the seek operation may be an independent operation that does not need to be preceded by a seek operation. In an example embodiment, the select operation is determined when a user lifts a finger off of the on-screen keyboard. However, it will be appreciated that other gestures may be performed to select a key (e.g., a tap gesture and so on).

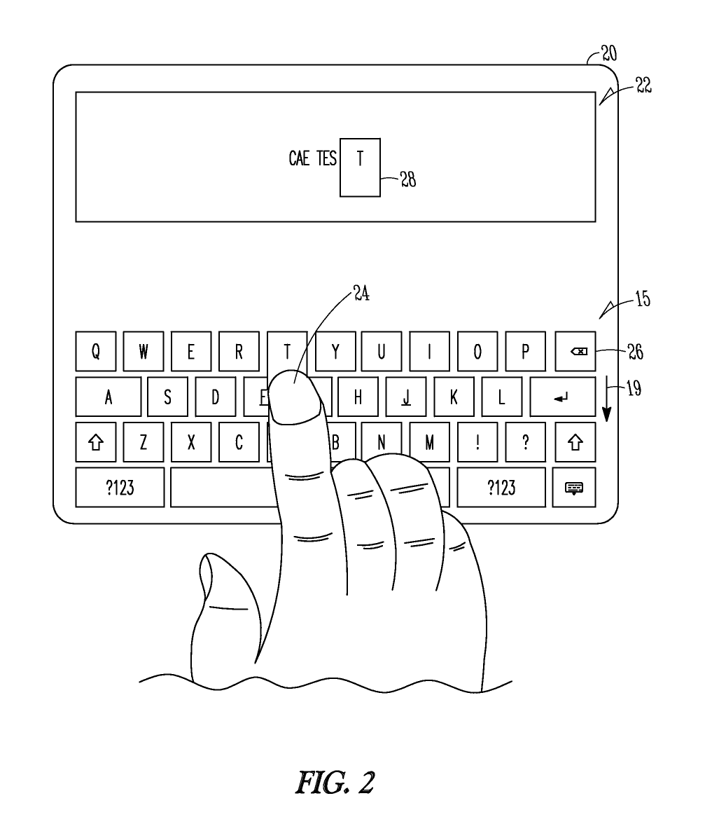

When a user's finger is on top of a key, a visual confirmation on the selected key may be provided to the user. Visual feedback (for example, providing an enlarged or exploded view of a key or portion of a key) may facilitate the user performing a swipe gesture down to the enlarged area to select a key. In some example embodiments, any type of downward motion by a finger on the surface of the display can be used for selection of an activated key. In an example embodiment, an increased active area of the key corresponding to the exploded or enlarged key is provided. Accordingly, a larger area of the keyboard may be swiped by the user, thus facilitating selection of the key. In an example embodiment, the enlarged active area may be of any size or shape and protrude at least partly in a downward direction. Haptic feedback may be provided to the user during the swiping motion. After the gesture is done and the finger is lifted, the chosen character may appear in the text window or content area (e.g., see FIG. 2). The haptic effect provided may, for example, be a feeling of crossing lines (line texture) or feeling a single, short effect during the swipe.

Referring to the drawings, FIGS. 1A and 1B show schematic representations of virtual or on-screen keyboards 10 and 15, in accordance with example embodiments, on a touch-sensitive screen of an electronic device. Examples of the electronic devices include a smart phone, a tablet computer, a display in a vehicle, or any electronic device equipped with a touch-sensitive screen to provide a GUI to a user.

The keyboard 10 is shown to include a plurality of “soft keys” 12 arranged as a “QWERTY” keyboard. Likewise, the keyboard 15 may include a plurality of soft keys 16. It is, however, to be appreciated that the methods/systems/devices described herein may be deployed on any GUI, which may, or may not, include letters of the alphabet and/or a numerical keypad. For example, in some embodiments, the soft keys 12,16 may be graphical objects representing other functions or selection options provided on a touch-sensitive display screen to a user. For example, in an automobile application, soft keys 12, 16 may be replaced with appropriate icons that may be used to navigate media player functionality, browse vehicle information, interact with a navigation system, or the like.

In the example keyboards 10, 15, when a user's finger is positioned over (or in proximity to) a particular soft key (e.g., the soft key “T”), the icon displaying the particular letter is enlarged (see enlarged “T” icons 14, 18). The user may then select the letter “T” by swiping his or her finger in a downward direction 19 to select the letter. It will be noted that the keys are arranged in horizontal rows and, accordingly, the downward direction is transverse to the rows. The enlargement of an icon (e.g., the “T” icon) on the keyboards 10, 15 provides visual feedback to a user of the keyboards 10, 15. It is to be appreciated that, although the keyboards 10, are shown to include round and square graphical objects in the form of keys, other shapes are provided in other example embodiments.

FIG. 2 shows some example embodiments of the GUI including a keyboard area and a display or content area where text (or alphanumeric characters including letters and/or numerals) is displayed as a user selects a key. An example of this configuration is shown in FIG. 2. More particularly, FIG. 2 shows a schematic representation of display 20 displaying a GUI, in accordance with an example embodiment, including a keyboard area and a content area 22. The keyboard area is shown to include the example keyboard 15 of FIG. 1B, merely by way of example, and other keyboard layouts are used in other embodiments. As a user selects a key on the keyboard 15, the corresponding letter is added to the content area 22. In the example shown in FIG. 2, the user has already entered the letters “Cae tes,” and the user is currently in the process of selecting the letter “T.” For example, upon a downward swipe (see downward direction 19) of a user's finger 24, the letter “T” will be added to the content area 22, thereby forming the words “Cae test.” The user may delete a letter (or numeral) using the backspace key 26. Other functionality provided with conventional touch screen keyboards may also be provided.

In an example embodiment, the content area 22 includes the text being edited or entered, and a ghost key overlay 28 (e.g., full or part of the keyboard and optionally semi-transparent) may provide the user with visual feedback of a key engaged by the user and optionally selected. The ghost key overlay 28 may direct the visual attention of the user to the content area 22 instead of the keyboard 15.

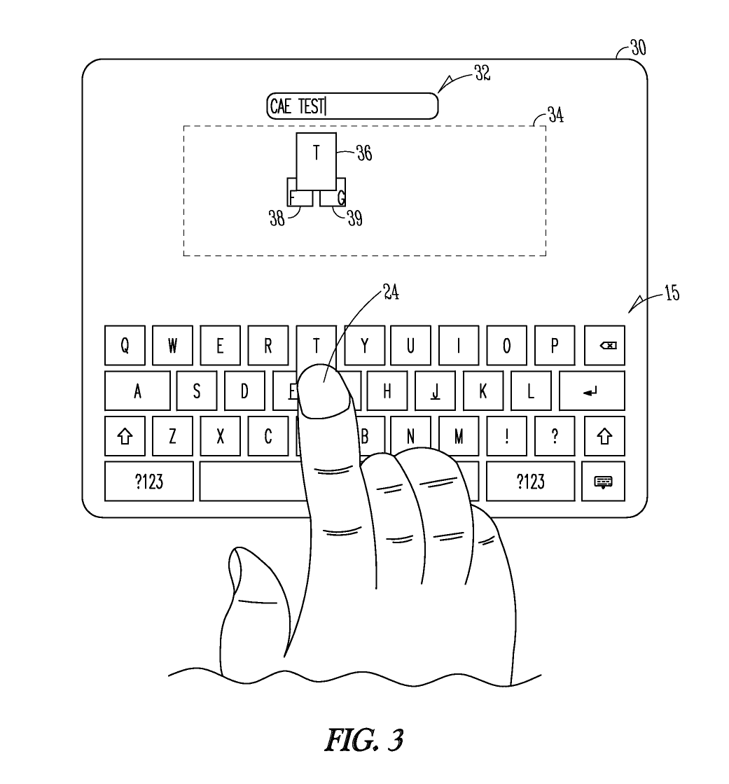

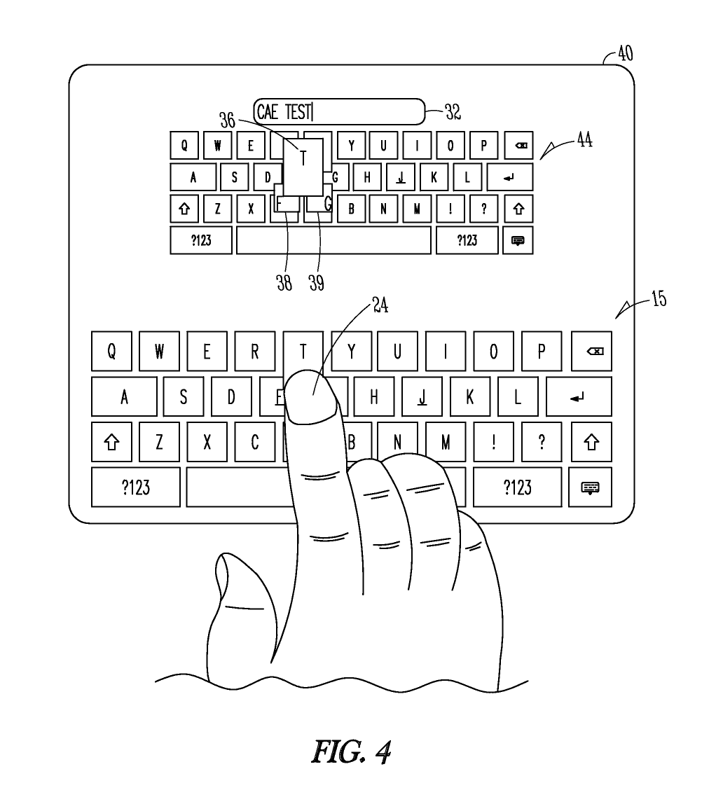

FIG. 3 shows a schematic representation of a display displaying a GUI 30, in accordance with an example embodiment, including a keyboard area, a content area 32 and a key proximity zone 34. As shown by way of example in FIG. 2, the keyboard area is shown to display the keyboard 15, although different keyboards may be used in different embodiments. The key proximity zone 34 shows a subset or portion of the keyboard 15 where the user's finger 24 is positioned on the on-screen keyboard. In the example shown in FIG. 3, the user's finger 24 is proximate the letter “T” and, accordingly, also proximate the letter “F” and “G” of a standard QWERTY keyboard. Accordingly, at least a portion 38 of the letter “F” and at least a portion 39 of the letter “G” are shown in the key proximity zone 34. In example embodiments, the activated key (e.g., the key 36) is shown in the key proximity zone 34. Thus, in an example embodiment, the activated key and at least some of its surrounding keys are shown in the key proximity zone 34. In an example embodiment, a haptic effect is generated to indicate to a user that the finger 24 is in contact with more than one key on the keyboard 15.

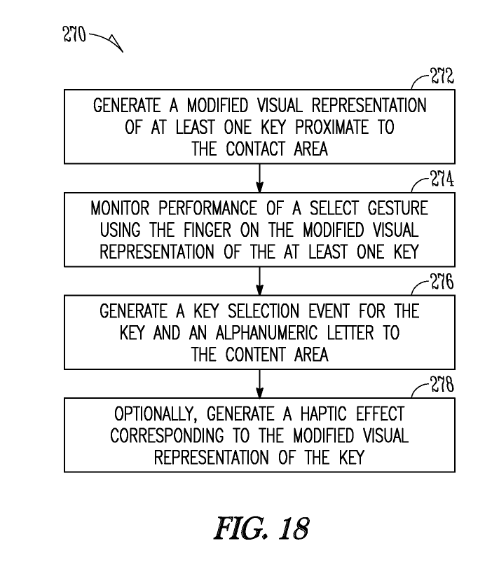

FIG. 17 shows a method 235, in accordance with an example embodiment, for providing haptic feedback when a finger covers at least a portion of two or more keys of an on-screen keyboard. As shown at block 236, the method 235 determines that the contact area between a user's finger 24 and the touch sensitive screen covers at least a portion of two or more keys of the on-screen keyboard (e.g., the keyboard 15). In the example shown in FIG. 3, the user's finger 24 may be positioned partially on the “T” key, the “F” key, and the “G” key. In order to indicate to the user that the finger 24 is not accurately positioned on the “T” key, the method 235 may generate a haptic effect (see block 238) that provides haptic feedback to the finger 24 to indicate that the finger 24 covers at least a portion of the “F” and “G” keys of the on-screen keyboard 15.

FIG. 4 shows a schematic representation of display 40, in accordance with an example embodiment, similar to the display 30 of FIG. 3, but including a full ghost keyboard 44 in a key proximity zone. As in the case of the display 30, the display 40 includes the content area 32 and a key proximity zone. The key proximity zone shows a subset or portion of the keyboard 15 where the user's finger 24 is positioned relative to the ghost keyboard 44. Similar to FIG. 3, in the display 40, the user's finger 24 is proximate the letter “T” and, accordingly, also proximate the letter “F” and “G” of a standard QWERTY keyboard. Accordingly, at least a portion 38 of the letter “F” and at least a portion 39 of the letter “G” are shown on the ghost keyboard 44 in the key proximity zone. Thus, in an example embodiment, the activated key 36 and at least some of its surrounding keys are shown in the key proximity zone with respect to the entire keyboard. In example embodiments, multi-touch configurations (also with multiple tactile areas) may be provided. Multi-touch functionality may allow fingers to be kept on several keys on the keyboard (e.g., the keyboard 15), and the user can see on the ghost keyboard where the fingers are touching or engaging the keyboard 15. In an example embodiment, only when a user lifts up a finger from a key on the keyboard (e.g., the keyboard 15) is the selection of a key triggered. Accordingly, in an example embodiment, other fingers may touch (or remain in contact with) the keyboard but a key is selected when one of the fingers is lifted or raised from the keyboard. In some embodiments, to not select a key, the user may be required to slide the finger (or fingers) off the keyboard (e.g., the keyboard 15) or to an inactive area of the keyboard (e.g., between keys) before lifting the finger or fingers up off the display 40.

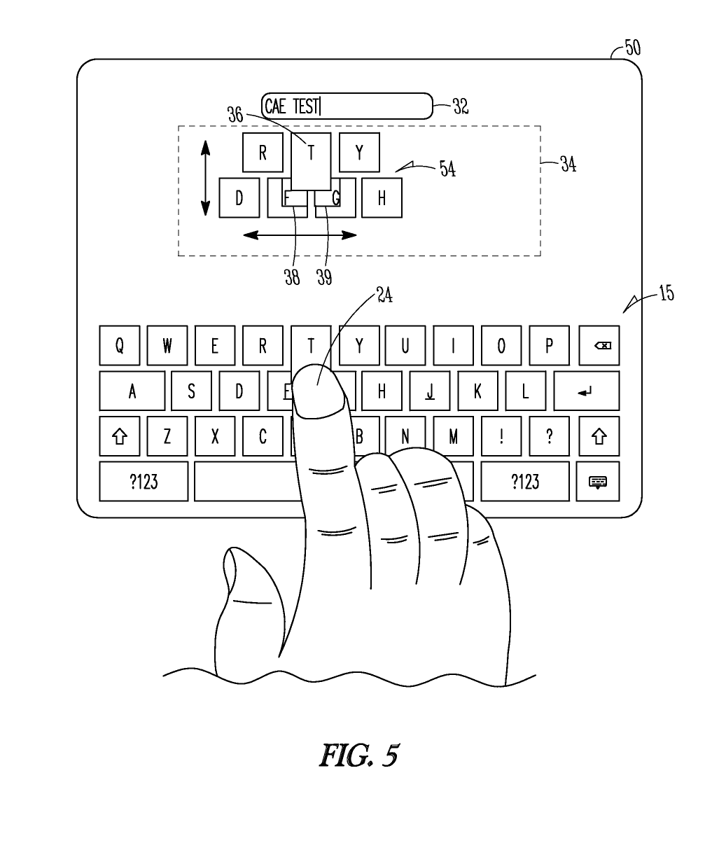

FIG. 5 shows a schematic representation of display 50, in accordance with an example embodiment, similar to the display 30 of FIG. 3 but displaying a GUI including a partial ghost keyboard 54 in a key proximity zone 34 positioned below a content area 32 (text input field). An activated key (the “T” key 36 in the illustrated example) and portions of its surroundings keys (the “F” key 38 and the “G” key 39 in the illustrated example) are highlighted or shown in exploded view on the display 50 to indicate the position or location of the finger 24. In the example display 50, the surroundings keys (the “F” key 38 and the “G” key 39 in the illustrated example) are only partially shown. It is, however, to be appreciated that any portion or the entire surrounding key or keys may be highlighted on the display.

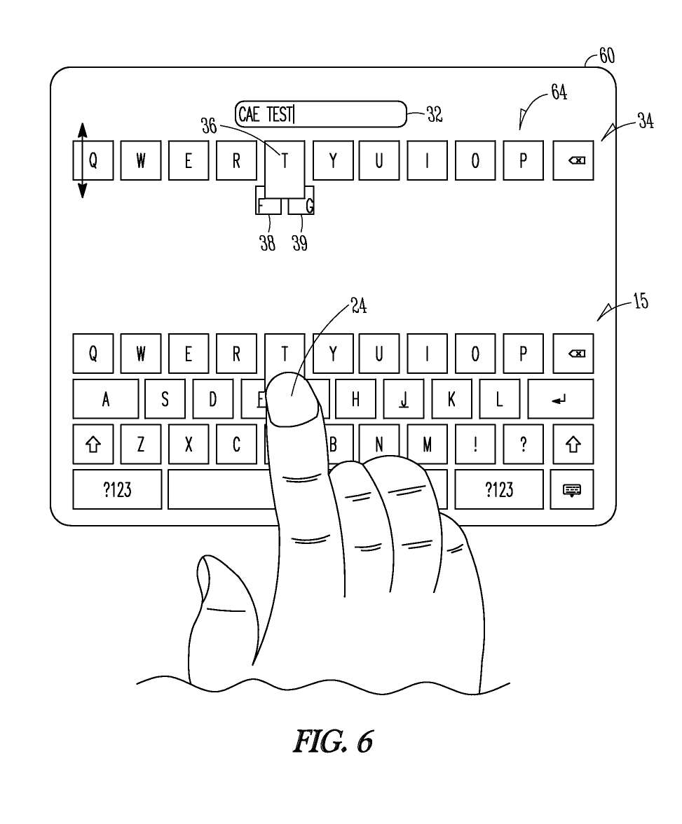

FIG. 6 shows a schematic representation of display 60, in accordance with an example embodiment, similar to the display 30 of FIG. 3 but displaying a GUI with a partial ghost keyboard 64 arranged linearly in a key proximity zone 34. As shown by way of example in FIGS. 3-5, an activated key (the “T” key 36) and its surroundings keys (the “F” key 38 and the “G” key 39) are highlighted or exploded on the display 60 to indicate the position or location of the finger 24. In the example display 60, the surroundings keys (the “F” key 38 and the “G” key 39) are only partially shown.

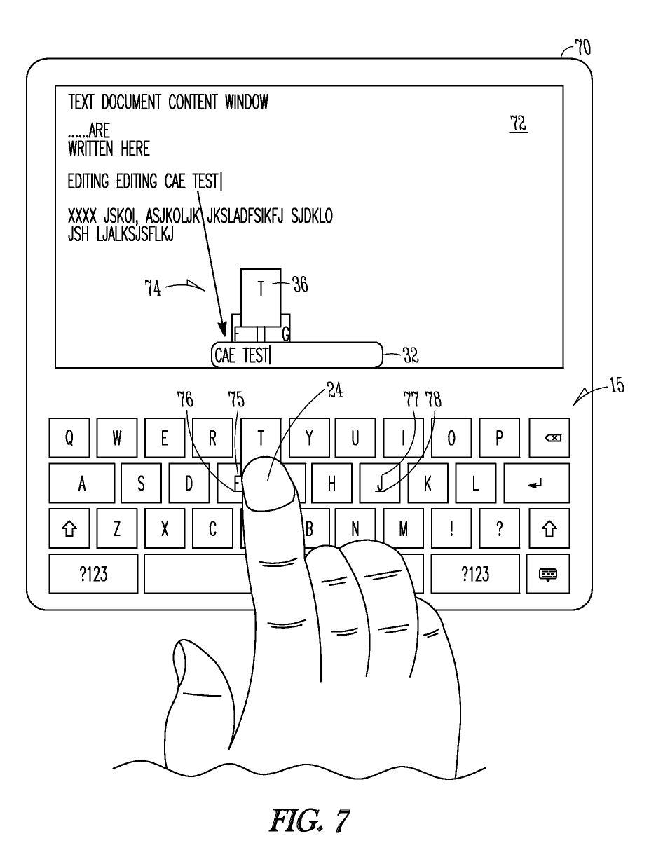

FIG. 7 shows a schematic representation of display 70, in accordance with an example embodiment, similar to the display 30 of FIG. 3 but displaying a GUI including document content window 72. The document content window 72 displays text being entered or edited by a user. A portion of the text being entered or edited by the user (“Cae test” in the illustrated example) is shown to be repeated in the content area 32 (or text input field). Unlike the content area 32 that is positioned, by way of example, above the key proximity zone 34 in FIG. 3, the content area 32 shown in FIG. 7 is positioned, by way of example, below the key proximity zone 74.

Anchor positions are provided on physical keyboards in the “F” and “J” keys in the form of raised bumps. The raised anchor positions facilitate a user identifying a “home row” where the fingers on a left hand can rest on the remaining keys beside the “F” key (i.e., the keys “F,” “D,” “S,” and “A” on a QWERTY keyboard), and the right hand can rest on the keys beside the “J” key (i.e., the keys “J,” “K,” and “L”).

In an example embodiment of the present application, the virtual keyboard includes identifiers or virtual anchors to identify anchor positions on the virtual keyboard. Accordingly, the example keyboard 15 shown in FIG. 7 is shown to include an anchor 76 on the “F” key 75 and an anchor 78 on the “J” key 77. The anchors 76 and 78 provide a haptic feedback when a user positions one of his or her fingers 24 in proximity to the anchors 76 and 78 in a manner similar to a physical keyboard. In an example embodiment, the anchors 76, 78 (or anchor lines) offer a short click-type feedback when the finger 24 crosses the anchor 76, 78.

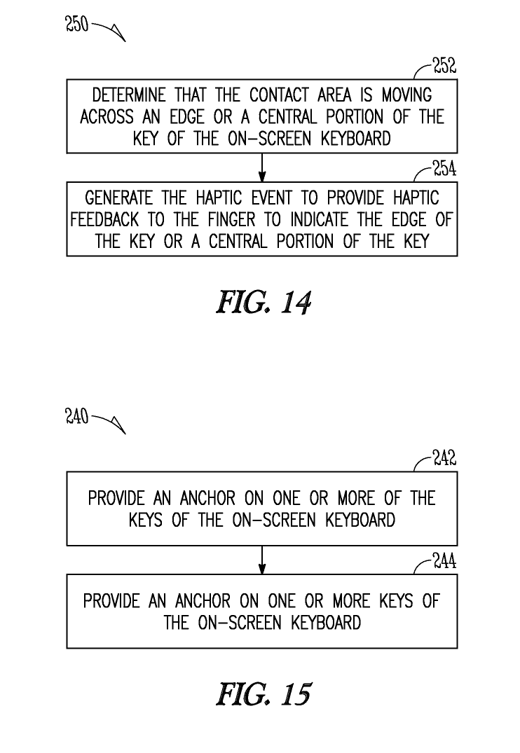

FIG. 15 shows a method 240, in accordance with an example embodiment, for identifying anchor keys on an on-screen keyboard (e.g., the keyboard 15). As shown at block 242, the method 240 may provide an anchor on one or more keys of the on-screen keyboard. Thereafter, the method 240 provides a haptic effect to a finger (or fingers) when the finger(s) is proximate to an anchor(s), as shown at block 244. When the keyboard is a QWERTY keyboard, anchors may be provided on the “F” and “J” keys, as described above. Accordingly, the circuitry described herein by way of example with reference to FIGS. 11 and 19, may provide a haptic effect at positions on the keyboard corresponding to the anchors 76 and 78. It will be appreciated that a different haptic effect or sensation is provided when a user's finger or fingers are proximate the anchors 76 and 78 than when the user's finger or fingers are resting on other keys of the on-screen keyboard. As mentioned herein, circuitry used to drive the on-screen keyboard may monitor the movement of a user's finger across the on-screen keyboard during a seek operation. In an example embodiment, the circuitry is configured to allow one finger to rest on one of the anchors and 76 and 78 and monitor the position of another finger on the on-screen keyboard while it traverses the keyboard. Thus, the user may still receive haptic feedback from the keyboard at one of the anchor position 76 and 78 while another finger (or other fingers) can select other keys on the on-screen keyboard.

As mentioned herein, in an example embodiment, a key may be selected by a swiping motion (e.g., a downward swiping motion) on a virtual key on the virtual keyboard (e.g., the virtual keyboard 15). Further, in an example embodiment, a haptic and/or visual feedback of the user's swiping motion may be provided. Example circuitry to implement haptic feedback on any one of the example virtual keyboards is shown in FIGS. 11 and 19.

It should be noted that, in some example embodiments, swiping is not essential for the selection of the key. For example, in other example embodiments, a lift-off event occurring when a user lifts a finger off the virtual keyboard can trigger the selection of a key. It should be noted that, in example embodiments, other fingers may remain on the keyboard during a lift-off event. However, in example embodiments where a swipe motion (e.g., a downward swipe motion) is used, provision of a haptic effect or feedback may be facilitated as the user's finger (or fingers) are still in contact with the touch-sensitive display screen.

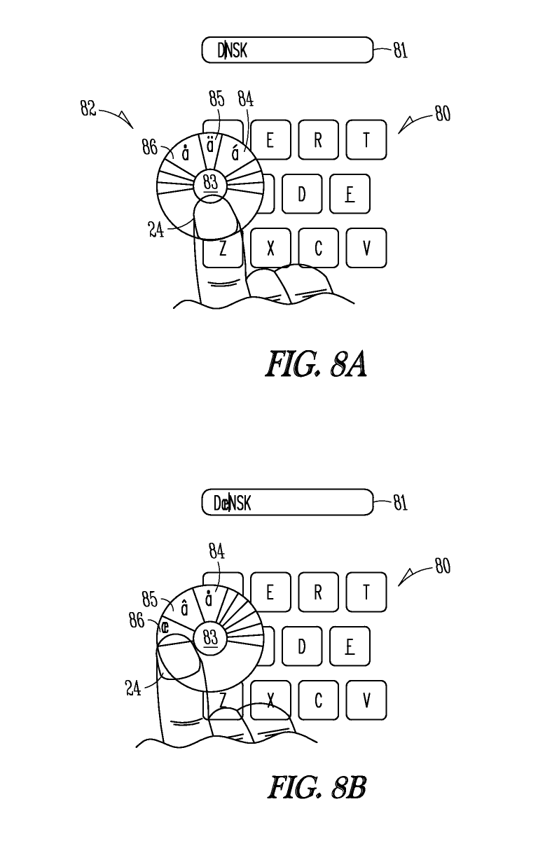

Example embodiments provide a virtual keyboard (e.g., the virtual keyboard 15) with special character options to allow a user to select special characters. FIGS. 8A and 8B show a schematic representation of a GUI including a virtual keyboard 80, in accordance with an example embodiment, on a touch-sensitive screen of an electronic device. The virtual keyboard 80 is shown to provide a special character selector 82 and, optionally, a content area 81. In example embodiments, the virtual keyboard 80 provides haptic feedback to a user interacting with the keys of the keyboard. Haptic feedback may also be provided on the special character selector 82 that, in the illustrated example, is configured as a circular disk or wheel. The special character selector 82 is shown to include a plurality of segments, each of which may individually provide a haptic feedback (e.g., a different haptic effect from each segment) as a finger 24 of the user traverses the special character selector 82. The special character selector 82 is shown, by way of example, to include segments 84, 85, and 86, which each correspond to a different special character corresponding to the letter “A.” In an example embodiment, when the user's finger 24 engages or touches a particular key on the virtual keyboard 80 for a particular duration, the special character selector 82 may be displayed to the user. In the example embodiment shown in FIGS. 8A and 8B, the special characters selector 82 is displayed as an overlay to the regular keys of the keyboard 80.

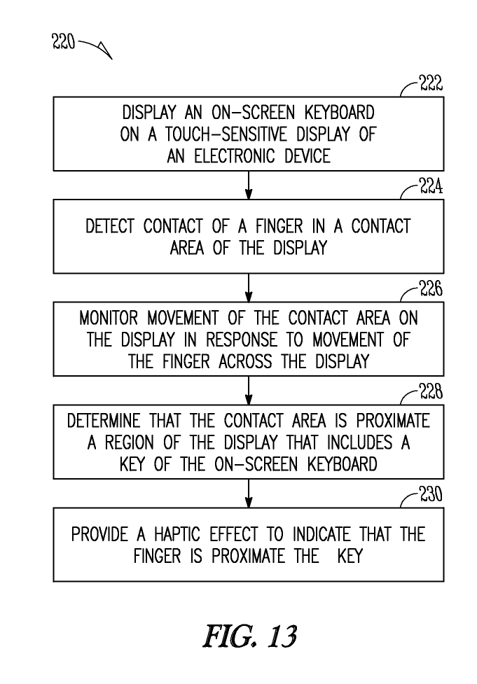

As shown in FIG. 8B, when a user slides his or her finger 24 from a central portion 83 of the special character selector 82 onto a segment, the particular segment is highlighted. In the example shown in FIG. 8B, the user's finger 24 is shown to be swiped or slid onto the segment 86. The user may then select the particular special character corresponding to the segment 86 using a tapping motion, a sliding motion, lifting the finger off the special character selector 82, a downward swiping motion, or the like. During selection of a key on the virtual keyboard 80, or selection of a special character on the special character selector 82, a haptic feedback (e.g., a click sensation) is provided to the user (see example method 220 of FIG. 13). In the illustrated example embodiment, the user is shown to be pressing or engaging with the “A” key on the virtual keyboard 80 and, accordingly, special characters corresponding to the letter “A” are shown on the special character selector 82. The time duration for which the user interacts with the virtual keyboard 80 in order to prompt the display of the special character selector 82 may very from embodiment to embodiment. In one example embodiment, the duration is about 1 second. In some embodiments, the special character selector 82 is a disc-shaped key selector, a vertical key slider, a horizontal key slider, or the like.

FIG. 13 shows a method 220, in accordance with an example embodiment, for providing a haptic effect to a user of an on-screen keyboard. The example method 220 may be implemented by the example hardware shown in FIGS. 11 and 19. As shown at block 222, the method 220 commences by displaying an on-screen keyboard on a touch-sensitive display of an electronic device. Thereafter, as shown at block 224, contact of a finger in a contact area of the touch sensitive display is detected. Thereafter, movement of the contact area on the display in response to movement of the finger across the display is monitored, as shown at block 226. The method 220 may then determine that the contact area is proximate a region of the display that includes a key of the on-screen keyboard (see block 228). For example, when the user's finger 24 is in proximity to the “T” key, a haptic effect (see block 230) can be provided to the user's finger 24 to indicate that the user's finger 24 is in proximity to a soft key on the on-screen keyboard 15. If the user was to move his or her finger 24 away from the “T” key, the haptic effect in the region of the “T” key would terminate and, in some example embodiments, a different haptic effect would then be provided proximate an adjacent key as the finger 24 moves across the adjacent key. As described herein with reference to FIG. 14, haptic feedback may be provided as the user's finger 24 traverses an edge of a soft key.

Example embodiments provide a virtual keyboard (e.g., the virtual keyboard 15) with sliders for special keys. For example, some of the special keys on a keyboard (e.g., a shift key, a space bar, etc., on the keyboard 15) can be transformed into functional sliders or controls. Slider transformation may be activated if a slider-enabled key is engaged, pressed, tapped, or otherwise activated by the user for a suitable duration (e.g., a preset duration or a long press/activation by a finger).

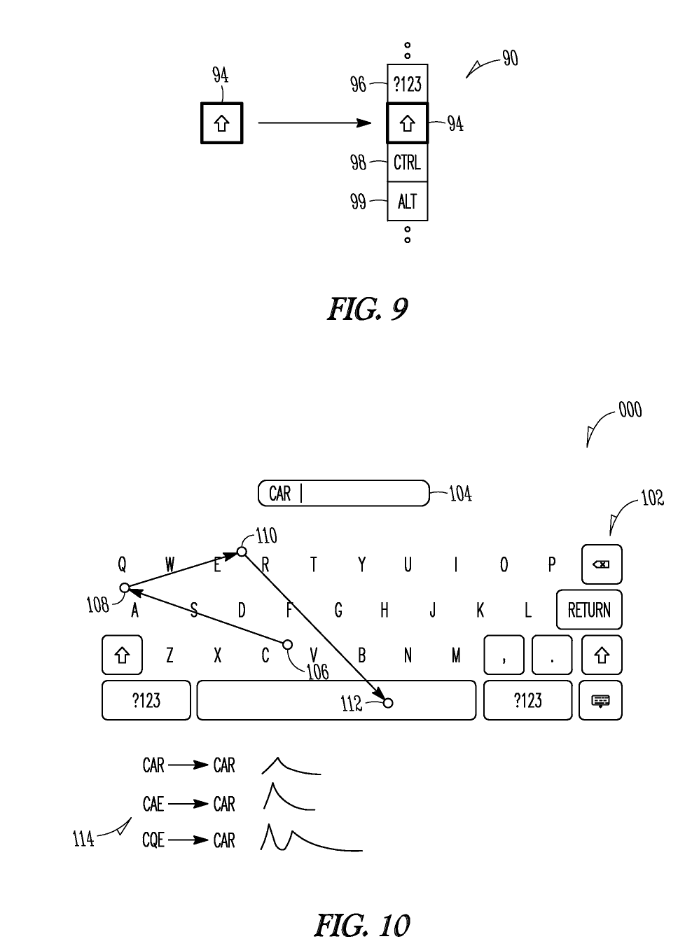

FIG. 9 shows a schematic representation of a display displaying a GUI, in accordance with an example embodiment, including a slider bar 90 corresponding to a selected key 94 on a virtual keyboard (e.g., the virtual keyboard 15). For example, when a user places his or her finger on the shift key 94 for a preset or reference duration (e.g. one second), the slider bar 90 may be displayed on the display proximate the virtual keyboard. For example, the slider bar 90 may overlay or be superimposed on existing keys on the virtual keyboard. As shown in FIG. 9, the slider bar 90 includes further virtual keys. For example, the slider bar 90 may include a key 96 to select a numeric keypad, a key 98 corresponding to a control key (CTRL), a key 99 corresponding to an ALT key, or the like. In the example embodiment shown in FIG. 9, activation of the shift key 94 provides a linear vertical list of other control characters (e.g., CTRL, ALT, etc.) available for selection. The user may select a key from the slider bar 90 by sliding the touch point of his or her finger from the shift key 94 vertically to an alternative control key. Haptic feedback (e.g., a “tic”) may be provided upon selection of a key in the slider bar 90. In some example embodiments, the slider bar 90 and the special character selector 82 have similar functionality.

The space bar on a keyboard is an important key having a large area, and it can have special uses, for example, such as word prediction, or performing start/stop functions in a media player. Accordingly, in an example embodiment, after a long press (e.g., 1 second), a slider bar may be displayed or the space key may change to a horizontal control slider (e.g., see slider bar 90). This slider bar can, for example, move a cursor, be used as arrow keys (left/right direction), or let the user move inside a predicted word list displayed in the GUI to select a preferred function. In an example embodiment, haptic feedback is provided in response to a user sliding a finger along an elongated space bar. In some example embodiments, both long press activation (e.g. indicated by a haptic effect providing a bump feel) and moving the slider between control keys (e.g. haptic “tic” feedback) may be felt. This may enable blind control use of the space bar. In an example embodiment, when a user continues to keep his or finger on a particular key after the key has been selected, the selection may be reversed. For example, if the user were to select the letter “T,” but continue to hold a finger on the “T” key, the “T” would be removed from the text input field.

In an example embodiment, a long touch or press (e.g., the user retains his or her finger on a particular key longer than the time period required for selection) may cause the circuitry to generate a menu. For example, engaging with the key for more than one second may activate and display a menu from which the user may select various menu options. The menu may be similar to the special character selector 82 and, accordingly, the same haptic feedback and selection functionality may be provided. If the user retains his or her finger on the menu for a prolonged period of time (e.g. greater than one second), the menu may then disappear from the on-screen keyboard.

In an example embodiment configured for multi-touch input, combinations of control modes can be used. For example, a space bar slider can be activated immediately by touching the shift key with another finger, and other sliding controls on the space bar can then be used with another finger (e.g., a finger on another hand).

In example embodiments, visual edges showing edges of the virtual keys may be removed from the on-screen keyboard as typing progresses. Virtual keys on the virtual or on-screen keyboard (e.g., the virtual keyboard 15) are configured to be felt as haptic bumps (e.g. texture effect) on the surface (see FIG. 14). Thus, as a user moves his or her fingers across the haptic keyboard, bumps may be felt by the fingers due to the haptic feedback as the fingers pass over the keys of the on-screen keyboard. This functionality may be implemented by the circuitry shown in FIGS. 11 and 13.

Special keys on the virtual keyboard, such as “shift” or “enter,” can be provided with a different type of haptic effect than the keys corresponding to letters of the alphabet. Accordingly, haptic feedback can be used to distinguish between different keys on the on-screen keyboard. In an example embodiment, the entire surface of the virtual keyboard may be a probability area, and electronic circuitry (see FIGS. 11 and 19) may predict which character the user is about to select. When the user has selected characters or letters that form a word, the user may then select the space button that then may automatically correct the typed word if it was spelled incorrectly. Haptic feedback may be given at the same instant when the space is hit to indicate how much the typed word was corrected (e.g., increased magnitude, longer rhythms to indicate more correction).

FIG. 10 shows a schematic representation of a display screen displaying a GUI 100, in accordance with an example embodiment, including markers (e.g., dots) marking contact points or key selections of a user typing on a virtual keyboard 102. The GUI 100 shows an interaction of the user with the virtual keyboard 102 at a word level. In the example GUI 100, the user is shown to select activate keys at position 106, followed by position 108, then at position 110 and finally at position 112 (the space bar). Software operating in conjunction with the keyboard 102 may disambiguate position errors. If the user selected the letters “Cae” or “Cqc” due to a positioning error, the software interprets the word entered as “car” (see blocks 104 and 114).

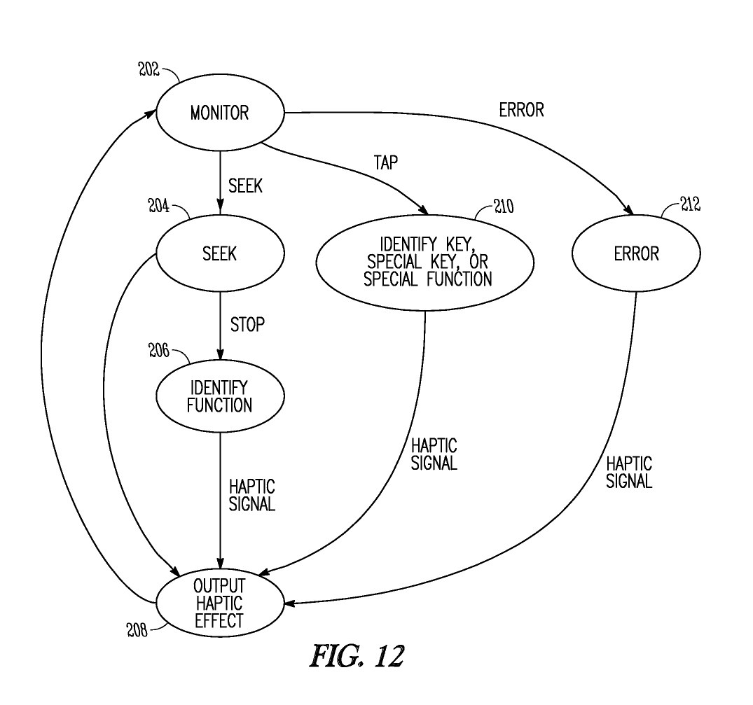

FIG. 11 shows a schematic representation of an electronic device 120 (e.g., a smart phone, a tablet computer such as an iPad, or any other computing device (portable or otherwise)) that may perform one or more of the methodologies described herein. The computer system 120 may, for example, implement the state transition diagram described with respect to FIG. 12.

FIG. 12 is an example state transition diagram 200 of a method for generating haptic effects, according to some example embodiments. The method may include a seek operation where a user seeks a key followed by a selection operation when the user selects the key that has been found in the seek operation.

In a monitor state 202, touches or interactions by a user with a virtual keyboard (e.g., the virtual keyboard 15) are detected and tracked. When a seek operation is detected, the state transitions to a seek state 204. A haptic signal is generated and a haptic effect is output to a haptic display (e.g., output to the virtual keyboard 15) in state 208. For example, during the seek operations, haptic effects corresponding to the key boundaries and/or the keys themselves (e.g., see FIGS. 1-10) may be generated as a user's finger moves across the keys of the virtual keyboard, as described by way of example herein. The state is then shown to return to state 202.

When it is determined that the finger has stopped (e.g., on a key of a virtual keyboard 15), the state transitions to state 206, in which a function is determined. For example, the function may include a key selection function (e.g., via a lift event, via a select event, a swiping motion, a tapping action, etc.) or an error handling function. A haptic signal corresponding to the identified function is then generated, and a haptic effect is output to the haptic display in state 208.

When a tap operation is detected (e.g., a key of the virtual keyboard is touched for a predetermined amount of time and then released), a key, a special key (e.g., symbols, accented characters, multi-stroke characters or the like), and/or a special function (e.g., sliders, key selectors, etc.) may be identified in state 210. Optionally, a haptic signal corresponding to the identified key, the special key, and/or the special function is generated, and a haptic effect is output to the haptic display in state 208. In an example embodiment, when an error is detected, the error is handled in state 212. A haptic signal corresponding to the error is optionally generated, and a haptic effect is output to the haptic display in state 208. It should be noted that different states in the state transition diagram 200 need not necessarily provide haptic feedback. For example, Haptic and/or visual feedback may be provided (e.g., following a tap as shown in sate 210).

As discussed herein, the circuitry used to drive the on-screen keyboard may be configured so that a tap operation is required to select a key and, accordingly, other fingers of a user's hand may rest on the on-screen keyboard without triggering a select operation. In these example embodiments, a release operation followed by a subsequent touch operation defines the select operation. Preselected time delays may allow the circuitry that drives the on-screen keyboard to distinguish between a tap operation, when the user selects a key, and a seek operation, when the user traverses the keyboard to find a new key for selection. For example, a delay of more than 200 ms may be required to distinguish from a previous touch operation (e.g., a seek or select operation). In an example embodiment, a tap duration limit is set at less than 500 ms. In an example embodiment, the circuitry monitors a pause of the user's finger on a selected key and, if the pause exceeds a preset time duration (e.g., a pause of 200 ms or more) and is followed by a lift of the finger, followed by a touch on the same key, a tap operations is identified. Accordingly, the time duration that a user's finger is touching a key on the on-screen keyboard may be used to distinguish between seek and select operations. In an example embodiment, if a tap operation is not completed within 300 to 700 ms, the user's gesture is considered by the circuitry to be performance of a seek where the user is finding a key for selection. In an example embodiment, a tap operation is defined when the finger is lifted off the touch-sensitive display for at least 200 ms and then subsequently touches the key and the finger is then lifted (thus performing a tap operation on the on-screen keyboard), and a seek operation is defined when a completed tap operation is not performed within about 300 ms to 700 ms.

As described herein, some embodiments provide a system, an electronic device, a computer-readable storage medium including instructions, and a computer-implemented method for providing haptic feedback for an on-screen keyboard on a touch-sensitive display. An on-screen keyboard is displayed on a touch-sensitive display of the computer system or electronic device. A contact area of a finger touching the touch-sensitive display is then detected. Movement of the contact is tracked while the finger moves across the touch-sensitive display. When the detected contact area is determined to be moving in a region corresponding to a key (or at least one key) of the touch-sensitive display, a haptic effect is generated on the touch-sensitive display in the contact area. The haptic effect provides haptic feedback to the finger to indicate that the finger is proximate the key (or at least one key) of the on-screen keyboard.

In some embodiments, the haptic effect is generated on the touch-sensitive display in the area of the touch-sensitive display corresponding to the contact area. The contact area, and thus the finger, may be determined to be moving across an edge of a key of the on-screen keyboard. Accordingly, a haptic effect is provided by the example circuitry to provide haptic feedback to the finger to indicate the edge of the key. The haptic effect may be, for example, a click effect or a sensation to the finger. In an example embodiment, the haptic effect provides the feel of a raised shape located at the edge of the key. The raised shape may correspond to the shape of the edge of the key across which the finger is moving.

In addition or instead, a haptic effect may be generated on the touch-sensitive display in the contact area, and thus the area in which the finger is located, corresponding to a central portion of a key of the on-screen keyboard. Thus, a haptic effect that provides haptic feedback is provided to a user to indicate that a finger is proximate a central portion of a key. The haptic feedback may simulate a feeling in the user's finger of a rough texture, a convex shape, a concave shape, or the like. It will be noted that different haptic effects may be provided when the finger is proximate different regions of a key. For example, a different haptic effect may be provided when the user's finger traverses an edge of the key than when the user's finger is located on a central portion of the key.

FIG. 14 shows a method 250, in accordance with an example embodiment, for provide haptic feedback to a user of an on-screen keyboard (e.g., the on-screen keyboard 15) to indicate an edge of a key or a central portion of the key. As shown at block 252, the method 250 may determine that the contact area between the finger of the user and the on-screen keyboard is moving across an edge or central portion of the key of the on-screen keyboard. Thereafter, the method 250 generates a haptic effect at block 254 to provide haptic feedback to the finger to indicate the edge of the key, or provides a different haptic effect to indicate that the user's finger is proximate a central portion of the key.

In an example embodiment, the method 250 may determine that the contact area is determined to be covering at least a portion of two or more keys of the on-screen keyboard. The method 250 then provides a different haptic effect to alert the user that the finger covers at least a portion of two or more keys of the on-screen keyboard (e.g., see also FIGS. 1-3 where multiple keys are shown highlighted). In order to distinguish different touch scenarios on the on-screen keyboard, haptic effects having different predetermined durations and predetermined intensities may be generated. Thus, the predetermined duration and the predetermined intensity when the finger fully covers a key may be greater than a duration and an intensity when the finger only covers a portion of a key (or covers a portion of more than one key).

In some example embodiments, when it is determined that the contact area is covering at least a portion of a key of the on-screen keyboard, a modified visual representation (e.g., an enlarged representation) of the key may then then be generated. A haptic effect corresponding to the modified visual representation of the key may then be generated.

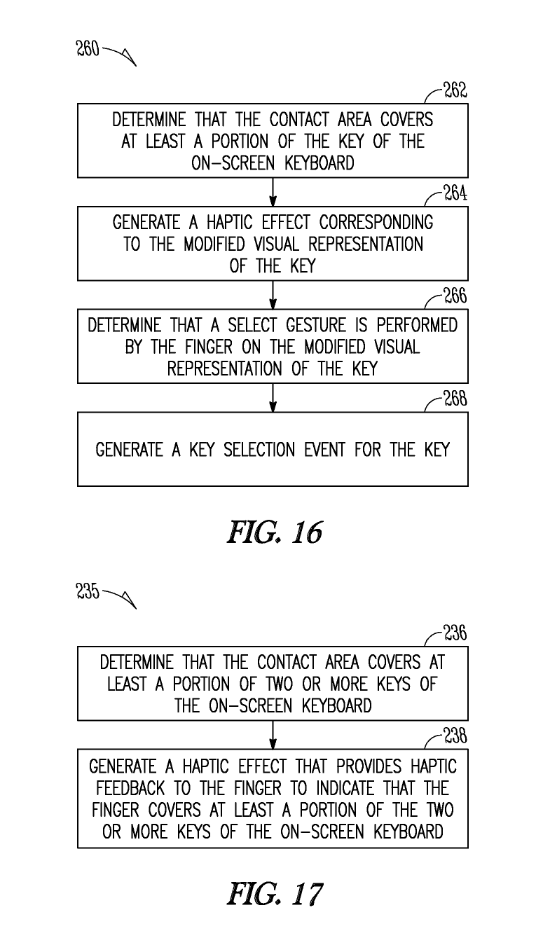

FIG. 16 shows a method 260 of generating a modified visual representation, in accordance with an example embodiment, of at least one key of the on-screen keyboard. As shown at block 262, the method 260 may determine that the contact covers at least a portion of a key of the on-screen keyboard (e.g., the “T” key of the on-screen keyboard 15). Thereafter, as shown at block 264, a haptic effect corresponding to the modified representation of the key is generated. Circuitry of the electronic device may then determine that a select gesture is performed by a finger (e.g., the finger 24) on the modified visual representation of the key (see block 266). As shown at block 268, a key selection event may then be generated for the key. The select gesture may, for example, be a downward swipe over the modified visual representation of the key. In the example embodiments, the select gesture includes a tap operation, a finger being lifted off of the touch-sensitive display over the modified visual representation of the key, or the like.

In some example embodiments, a word corresponding to a sequence of keys traversed by the contact area on the on-screen keyboard is identified (e.g. see FIG. 10). FIG. 18 shows a method 270, in accordance with an example embodiment, for displaying a modified representation of at least one key (e.g., the letter “T” of the example keyboard 15) proximate a contact area of an on-screen keyboard. As shown at block 272, the method 270 may generate a modified visual representation of at least one key proximate to the contact area. Thereafter, the method 270 may monitor performance of a select gesture using the finger on the modified visual representation of the at least one key at block 274. Thereafter, at block 276, a key selection event may be generated and, an alphanumeric letter corresponding to the key may be added to the content area. For example, the “T” may be added to the content area 22 of the display 20 (see FIG. 2).

Some example embodiments provide a method and electronic device implementing a method for identifying a selection of a key in an on-screen keyboard on a touch-sensitive display. An on-screen keyboard is displayed on a touch-sensitive display of the electronic device. A contact area of a finger touching the touch-sensitive display is detected. The contact area is then determined to be covering at least a portion of a key of the on-screen keyboard, and a modified visual representation of the key is generated to indicate that the finger is covering at least a portion of the key. When a select gesture is detected on the modified visual representation of the key, a key selection event for the key is generated. In some example embodiments, a haptic effect corresponding to the modified visual representation of the key that differs from other haptic feedback is generated.

In some example embodiments, a haptic effect is generated based on the modified visual representation of the key and the select gesture being performed on the modified visual representation of the key. Prior to determining that the select gesture is performed on the modified visual representation of the key, a visual representation of the key may be displayed at a text insertion point in a content area of the touch-sensitive display; a visual representation of the key may be displayed below a text insertion point in a content area of the touch-sensitive display; at least a portion of the on-screen keyboard including the modified representation of the key may be displayed below a text insertion point in a content area of the touch-sensitive display; and/or the contact area may be determined to be covering at least the portion of the key for at least a predetermined period of time; and a key selector including a plurality of variants for the key is displayed.

In some example embodiments, the contact area is determined to be moving over the key selector, and a haptic effect in the area of the touch-sensitive display corresponding to a location of the contact area over the key selector is generated. In some example embodiments, prior to determining that the select gesture is performed on the modified visual representation of the key, the contact area is determined to be covering at least the portion of the key for at least a predetermined period of time, and a scroll control slider is displayed. In some example embodiments, the contact area is determined to be moving over the scroll control slider, and a haptic effect in the area of the touch-sensitive display corresponding to a location of the contact area over the scroll control slider is generated. The scroll control slider may be a horizontal scroll control slider, a vertical scroll control slider, or the like.

### Example System Architecture

Referring to FIG. 11, the electronic device or computer system 120 includes a haptic touch-sensitive display 122, a processor 124, memory 126, a haptic processor 128, and a display driver 130. In some example embodiments, the haptic processor 128 and the processor 124 are combined. Thus, in an example embodiment, the generation of haptic effects is done by the same processor that the device (e.g., a smart phone) uses to perform its regular functionality. The haptic touch-sensitive display 122 includes a touch sensor 132 configured to detect finger contact on a haptic display 134 (see also FIGS. 1-10). The haptic display 134 is configured to display user interface objects (e.g., key of the keyboard 15) and to produce corresponding haptic effects as described herein.

The processor 124 executes application instructions 136 stored in the memory 126 and performs calculations on application data 138 stored in the memory 126. In doing so, the processor 124 may also generate a display signal 140 corresponding to user interface objects (e.g., text or other graphic elements of a graphical user interface) that is used by the display driver 130 to drive the haptic display 134 to produce user interface objects on the haptic display 134.

When finger contact is detected by the touch sensor 132 in a contact area, a contact location and time 142 (e.g., x-y coordinates and a timestamp) are communicated to the processor 124. The processor 124 transmits the contact location and time 142 to the haptic processor 128, which uses a keyboard configuration 144 and a haptic effects library 146 to generate a haptic effect signal 148. The haptic processor 128 transmits the haptic effect signal 148 to the display driver 130, which in turn drives the haptic display 134 to produce a haptic effect corresponding to the haptic effect signal 148. In some embodiments, the haptic effects library 146 is dependent on the keyboard configuration 144. For example, the locations of keys on the keyboard may determine the location of particular haptic effects to be generated on the keyboard. As mentioned above, the haptic processor 128 and processor 124 may be a single processor, two separate processors, two processors formed on the same piece of silicon, or otherwise implemented.

FIG. 19 depicts a block diagram of a machine in the example form of a computer system or electronic device 300 within which may be executed a set of instructions for causing the machine to perform any one or more of the methodologies discussed herein. In some example embodiments, the machine operates as a standalone device or may be connected (e.g., networked) to other machines. In a networked deployment, the machine may operate in the capacity of a server or a client machine in a server-client network environment or as a peer machine in a peer-to-peer (or distributed) network environment. In some embodiments, the computer system 300 includes components of the computer system 120.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the computer system 300 includes a processor 302 (e.g., a central processing unit (CPU), a graphics processing unit (GPU) or both), and memory 304, which communicate with each other via bus 308. Memory 304 includes volatile memory devices (e.g., DRAM, SRAM, DDR RAM, or other volatile solid state memory devices), non-volatile memory devices (e.g., magnetic disk memory devices, optical disk memory devices, flash memory devices, tape drives, or other non-volatile solid state memory devices), or a combination thereof. Memory 304 may optionally include one or more storage devices remotely located from the computer system 300. The computer system 300 may further include video display unit 306 (e.g., a plasma display, a liquid crystal display (LCD), or a cathode ray tube (CRT)). The computer system 300 also includes input devices 310 (e.g., keyboard, mouse, trackball, touchscreen display, etc.), output devices 312 (e.g., speakers), and a network interface device 316. The aforementioned components of the computer system 300 may be located within a single housing or case (e.g., as depicted by the dashed lines in FIG. 19). Alternatively, a subset of the components may be located outside of the housing. For example, the video display unit 306, the input devices 310, and the output device 312 may exist outside of the housing, but be coupled to the bus 308 via external ports or connectors accessible on the outside of the housing.

Memory 304 includes a machine-readable medium 320 on which is stored one or more sets of data structures and instructions 322 (e.g., software) embodying or utilized by any one or more of the methodologies or functions described herein. The one or more sets of data structures may store data. Note that a machine-readable medium refers to a storage medium that is readable by a machine (e.g., a computer-readable storage medium). The data structures and instructions 322 may also reside, completely or at least partially, within memory 304 and/or within the processor 302 during execution thereof by computer system 300, with memory 304 and processor 302 also constituting machine-readable, tangible media.

The data structures and instructions 322 may further be transmitted or received over a network 350 via network interface device 316 utilizing any one of a number of well-known transfer protocols (e.g., HyperText Transfer Protocol (HTTP)). Network 350 can generally include any type of wired or wireless communication channel capable of coupling together computing nodes (e.g., the computer system 300). This includes, but is not limited to, a local area network (LAN), a wide area network (WAN), or a combination of networks. In some embodiments, network 350 includes the Internet

Certain embodiments are described herein as including logic or a number of components, modules, or mechanisms. Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the computer system 300) or one or more hardware modules of a computer system (e.g., a processor 302 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 302 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 302 configured using software, the general-purpose processor 302 may be configured as respective different hardware modules at different times. Software may accordingly configure a processor 302, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

The various operations of example methods described herein may be performed, at least partially, by one or more processors 302 that are temporarily configured (e.g., by software, code, and/or instructions stored in a machine-readable medium) or permanently configured to perform the relevant operations. Whether temporarily or permanently configured, such processors 302 may constitute processor-implemented (or computer-implemented) modules that operate to perform one or more operations or functions. The modules referred to herein may, in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 302 or processor-implemented (or computer-implemented) modules. Similarly, at least some of the operations of a method may be governed by instructions that are stored in a computer readable storage medium and executed by one or more processors 302 or processor-implemented (or computer-implemented) modules. The performance of certain of the operations may be distributed among the one or more processors 302, not only residing within a single machine, but deployed across a number of machines. In some example embodiments, the processors 302 may be located in a single location (e.g., within a home environment, an office environment or as a server farm), while in other embodiments the processors 302 may be distributed across a number of locations.

While the embodiment(s) is (are) described with reference to various implementations and exploitations, it will be understood that these embodiments are illustrative, and that the scope of the embodiment(s) is not limited to them. In general, the embodiments described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and its practical applications, to thereby enable others skilled in the art to best utilize the embodiments and various embodiments with various modifications as are suited to the particular use contemplated.

What is claimed is:

1. A computer-implemented method comprising:
displaying an on-screen keyboard on a touch-sensitive display of an electronic device;
detecting contact of a finger in a contact area of the display;
monitoring movement of the contact area on display in response to movement of the finger across the display;
determining that the contact area is proximate a region of the display that includes a key of the on-screen keyboard; and
providing a haptic effect to indicate that the finger is proximate the at least one key.

2. The computer-implemented method of claim 1, wherein the haptic effect is provided via the display.

3. The computer-implemented method of claim 2, wherein the haptic effect is provided proximate to the detected contact area.

4. The computer-implemented method of claim 1, wherein the haptic effect provides haptic feedback to the finger to indicate that the finger is proximate the region of the touch-sensitive display including the key of the on-screen keyboard.

5. The computer-implemented method of claim 1, wherein providing the haptic effect on the display comprises:
determining that the contact area is moving across an edge of the key of the on-screen keyboard; and
generating the haptic effect to provide haptic feedback to the finger to indicate the edge of the key.

6. The computer-implemented method of claim 1, wherein the haptic effect is provided to the finger to simulate an edge of the key of the on-screen keyboard.

7. The computer-implemented method of claim 6, wherein the edge of the key is simulated by a raised shape generated via the on-screen keyboard.

8. The computer-implemented method of claim 1, wherein generating the haptic effect comprises:
determining that the contact area is moving across a central portion of the key of the on-screen keyboard; and
generating a haptic effect that provides haptic feedback to the finger to indicate the central portion of the key.

9. The computer-implemented method of claim 8, wherein the haptic effect that provides the haptic feedback to the finger to indicate the central portion of the key includes a rough texture.

10. The computer-implemented method of claim 1, wherein the on-screen keyboard includes a plurality of keys and the haptic effect associated with at least two keys of the plurality of keys differs.

11. The computer-implemented method of claim 1, wherein the haptic effect simulates touch by the finger of a convex shape.

12. The computer-implemented method of claim 1, wherein the haptic effect simulates touch by the finger of a concave shape.

13. The computer-implemented method claim 1, wherein the haptic effect is provided on the display in the area of the display corresponding to the contact area, the method including:
determining that the contact area covers at least a portion of two or more keys of the on-screen keyboard; and
generating a haptic effect that provides haptic feedback to the finger to indicate that the finger covers at least a portion of two or more keys of the on-screen keyboard.

14. The computer-implemented method of claim 13, wherein the haptic effect providing haptic feedback to the finger to indicate that the finger covers at least a portion of two or more keys of the on-screen keyboard comprises:
a haptic effect having a predetermined duration and a predetermined intensity, and wherein the predetermined duration and the predetermined intensity is greater than a duration and an intensity of a haptic effect that provides haptic feedback to the finger to indicate that the finger covers at least a portion of only a single key of the on-screen keyboard.

15. The computer-implemented method of claim 1, wherein determining that the contact area is proximate a region of the display that includes the key of the on-screen keyboard comprises determining that the contact area covers at least a portion of the key of the on-screen keyboard, the method further comprising:
generating a modified visual representation of the key to indicate that the finger is covering at least a portion of the key; and
generating a haptic effect corresponding to the modified visual representation of the key.

16. The computer-implemented method of claim 15, further comprising:
determining that a select gesture is performed by the finger on the modified visual representation of the key; and
generating a key selection event for the key.

17. The computer-implemented method of claim 16, wherein the keys of the on-screen keyboard are arranged in rows and the select gesture includes a downward swipe transverse to the rows and over the modified visual representation of the key.

18. The computer-implemented method of claim 16, further comprising generating a further haptic effect based on the modified visual representation of the key and the select gesture being performed on the modified visual representation of the key.

19. The computer-implemented method of claim 16, further comprising:
determining that the contact area covers at least a portion of a key of the on-screen keyboard;
determining that the finger is lifted off the touch-sensitive display over the modified visual representation of the key; and
generating a key selection event for the key.

20. The computer-implemented method of claim 19, wherein:
a tap operation is defined when the finger is lifted off the touch-sensitive display for at least 200 ms and then subsequently touches the key and the finger is then lifted; and
a seek operation is defined when a completed tap operation is not performed within about 300 ms to 700 ms.

21. The computer-implemented method of claim 1, further comprising:
providing an anchor on one or more keys of the on-screen keyboard; and
providing a further haptic effect to the finger when the finger is proximate to the anchor.

22. The computer-implemented method of claim 21, wherein an anchor is provided on each of the “F” and “J” keys of the on screen keyboard to simulate the anchors provided on the “F” and “J” keys of a physical keyboard.

23. The computer-implemented method of claim 1, further comprising:
generating a modified visual representation of at least one key proximate to the contact area; and
monitoring performance of a select gesture using the finger on the modified visual representation of the at least one key; and
generating a key selection event for the key that includes adding an alphanumeric letter to a content area.

24. The computer-implemented method of claim 23, wherein determining that the select gesture is performed on the modified visual representation of the key includes determining that the finger is lifted off of the display at a position over the modified visual representation of the key.

25. The computer-implemented method of claim 23, wherein the haptic effect corresponding to the modified visual representation of the key is generated.

26. The computer-implemented method of claim 23, wherein the haptic effect corresponding to the select gesture is generated.

27. The computer-implemented method of claim 23, wherein prior to determining that the select gesture is performed on the modified visual representation of the key, the method further comprises displaying a label of a selected key, at a text insertion point in the content area of the display.

28. The computer-implemented method of claim 23, wherein prior to determining that the select gesture is performed on the modified visual representation of the key, the method further comprises displaying a visual representation of the key below a text insertion point in the content area of the display.

29. The computer-implemented method of claim 23, wherein prior to determining that the select gesture is performed on the modified visual representation of the key, the method comprises displaying, below a text insertion point in the content area of the touch-sensitive display, at least a portion of the on-screen keyboard including the modified representation of key.

30. The computer-implemented method of claim 23, wherein prior to determining that the select gesture is performed on the modified visual representation of the key, the method comprises:
determining that the contact area covers at least the portion of the key for at least a predetermined period of time; and
displaying a key selector including a plurality of variants for the key.

31. The computer-implemented method of claim 30, further comprising:
determining that the contact area is moving over the key selector; and
generating a haptic effect in the area of the touch-sensitive display corresponding to a location of the contact area over the key selector.

32. The computer-implemented method of claim 30, wherein the key selector is a disc-shaped key selector.

33. The computer-implemented method of claim 30, wherein the key selector includes a plurality of variants arranged linearly in a key slider.

34. The computer-implemented method of claim 23, wherein prior to determining that the select gesture is performed on the modified visual representation of the key, the method comprises:
determining that the contact area covers at least the portion of the key for at least a predetermined period of time; and
displaying a scroll control slider.

35. The computer-implemented method of claim 34, further comprising:
determining that the contact area is moving over the scroll control slider; and
generating a haptic effect in the area of the touch-sensitive display corresponding to a location of the contact area over the scroll control slider.

36. A computer readable storage medium storing at least one program configured for execution by a computer, the at least one program comprising instructions to perform operations comprising:
displaying an on-screen keyboard on a touch-sensitive display of an electronic device;
detecting contact of a finger in a contact area of the display;
monitoring movement of the contact area on display in response to movement of the finger across the display;
determining that the contact area is proximate a region of the display that includes a key of the on-screen keyboard; and
providing a haptic effect to indicate that the finger is proximate the at least one key.

37. An electronic device comprising:
touch-sensitive display including haptic feedback functionality; and
a processing module configured to:
display an on-screen keyboard on the touch-sensitive display of the electronic device;
detect contact of a finger in a contact area of the display;
monitor movement of the contact area on display in response to movement of the finger across the display;
determine that the contact area is proximate a region of the display that includes a key of the on-screen keyboard; and
provide a haptic effect via the display to indicate that the finger is proximate the at least one key.
